(19) United States
(12) Patent Application Publication
(10) Pub. No.: US 2004/0073572 A1
(43) Pub. Date: Apr. 15, 2004

(54) Retail merchandise shelf location directory system

(76) Inventor: Peigen Jiang, Sunnyvale, CA (US)

Correspondence Address: PEIGEN JIANG, 306 PORTIA AVE, SUNNYVALE, CA, 94086, US

(21) Appl. No.: 10/268,852

(22) Filed: Oct. 10, 2002

(51) Int. Cl. G06F 7/00

(52) U.S. Cl. 707/104.1

(57) ABSTRACT

A merchandise shelf location directory system in a retail facility for its customers to conduct self-search for the merchandise shelf locations. The directory system consists of a networked computer system which hosts a database of merchandise items the retail facility carries, and the merchandise shelf location identification is one of the data items of the database. The networked computer system also includes a plurality of terminals for the retail facility customers to self-search and retrieve the merchandise location information from the database.

### CROSS-REFERENCE TO RELATED APPLICATIONS

| | | |
|---|---|---|
| 5,250,789 | October 1993 | Johnsen |
| 6,179,206 | January 2001 | Matsumori |
| 6,386,450 | May 2002 | Ogasawara |

### BACKGROUND OF THE INVENTION

1. Field of the Invention

The present invention relates generally to a directory system of merchandise shelf locations used in a retail facility, and more particularly to a networked computer implemented directory system in a retail facility, such as a department or hardware store, that enables its customers to conduct self-search for merchandise shelf locations.

2. Description of the Related Art

Searching for a particular merchandise item in a big department or hardware store can be very time-consuming and often frustrating without help. The conventional way for customers to quickly locate unfamiliar merchandise in a retail store is to ask a store clerk for direction. For the retail store, this way of helping customers was labor intensive. Also, human memory is always limited and prone to error. In a big department store with hundreds and thousands of items on display, customers may find store clerks not always having the right merchandise information.

U.S. Pat. No. 6,386,450 issued to Ogasawara describes an electronic personal shopping system. Its mobile terminal given to each customer is basically a mobile computer equiped with bar code scanner and IC card reader. The cost of such system will be prohibitive for it to be of any practical use. Besides, the sophisticated computing terminal is just too complicated for most customers to use if its goal is too save customer time.

### SUMMARY OF THE INVENTION

Accordingly, the primary objective of the present invention is to allow retail store customers to conduct self-search for merchandise shelf locations, so that the retail store can save labor cost with a modest investment in the equipments.

This objective is accomplished with the present invention by employing a networked computer system with a central server and multiple client terminals. The central server hosts a database of all the merchandise items the retail store carries, and the server also simultaneously processes all the requests from the multiple terminals. The client terminals are basically ordinary desktop computers, placed conveniently in the store for customers to conduct self-search in the database for the shelf locations of individual items. Each client terminal of said networked computer system is also equipped with a printing device to allow customer to print out his or her search result of the merchandise shelf locations.

The database of merchandise items is so programmed that customers can either browse by merchandise categories or search by texts, such as the merchandise name, brand name, product applications, or any other key words.

### BRIEF DESCRIPTION OF THE DRAWINGS

These and other features of the invention will now be described with reference to the drawings summarized below. The drawings and the associated description are provided to illustrate a preferred embodiment of the invention, and not to limit the scope of the invention.

FIG. 1 is a conceptual, simplified diagram of the merchandise shelf location directory system implemented with a computer network of a server and multiple terminals, and each terminal is also equipped with a printer;

FIG. 2 is a conceptual, simplified illustration of the structure of the database of merchandise items resided in the server;

FIG. 3 is an exemplary ‘home’ page displayed at the terminal monitors, where customers can conduct self-search for the merchandise shelf locations at the retail store, in ways of ‘Browse by Category’ or ‘Search by Text’;

FIG. 4 is an exemplary ‘Browse by Category’ page displayed at the terminal monitors, in which the merchandise shelf location identifications (ID) can be shown;

FIG. 5 is an exemplary ‘Search by Text’ result page displayed at the terminal monitor, in which the merchandise shelf location IDs of the matched merchandise items are shown.

### DETAILED DESCRIPTION OF THE INVENTION

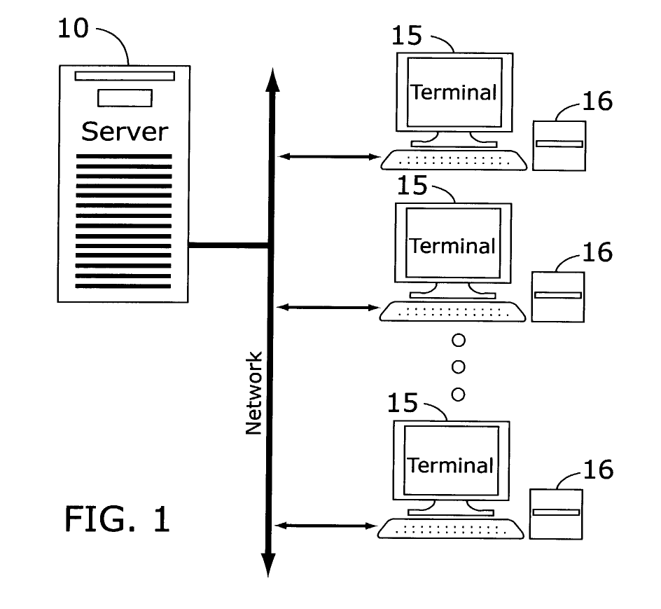

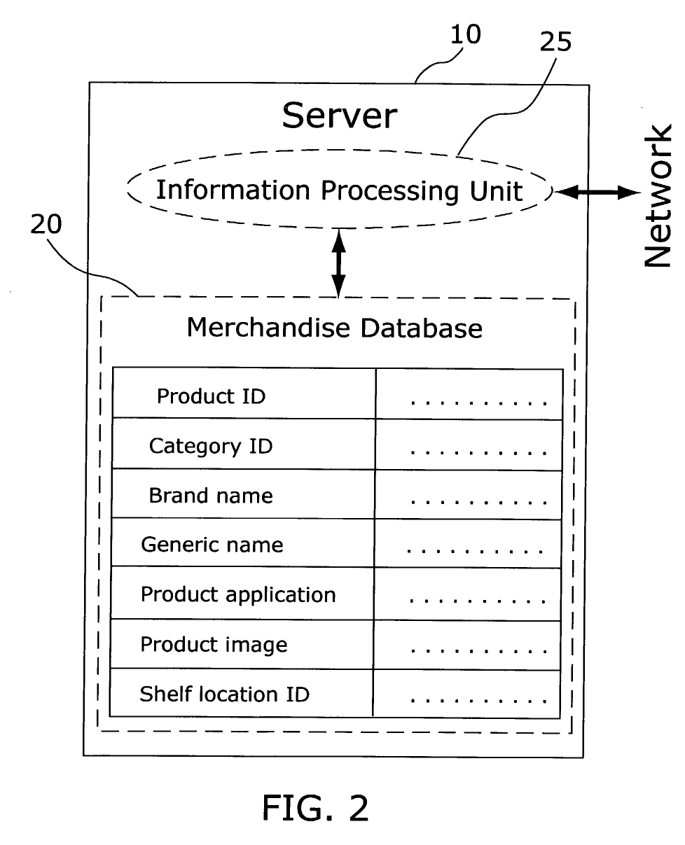

The present invention provides a merchandise shelf location directory system to assist retail store customers to quickly locate their desired items. FIG. 1 illustrates conceptually such a system implemented with a computer network of a server 10 and multiple terminals 15. Referring to FIG. 2, the server hosts a database of merchandise items 20 and the information processing unit 25 which can process all the requests from the terminals 15 simultaneously, and accesses the database of merchandise items 20. The construction of the said database depends on the characteristics of the merchandises the retail store carries. In the illustrated embodiment (FIG. 2), the database 20 has seven data items: product identification (ID), category identification (ID), brand name, generic name, product application, product image and shelf location identification (ID), and can have as many entries for the data items as the number of merchandise items demands, with each merchandise item occupies one entry.

The multiple terminals 15, conveniently placed throughout the store, are where the retail customers can conduct their self-searches for the merchandise shelf locations. Beside the feature of a basic desktop computer, every terminal 15 is also equipped with a printer 16, for the customers to print out search results of the desired merchandise shelf locations.

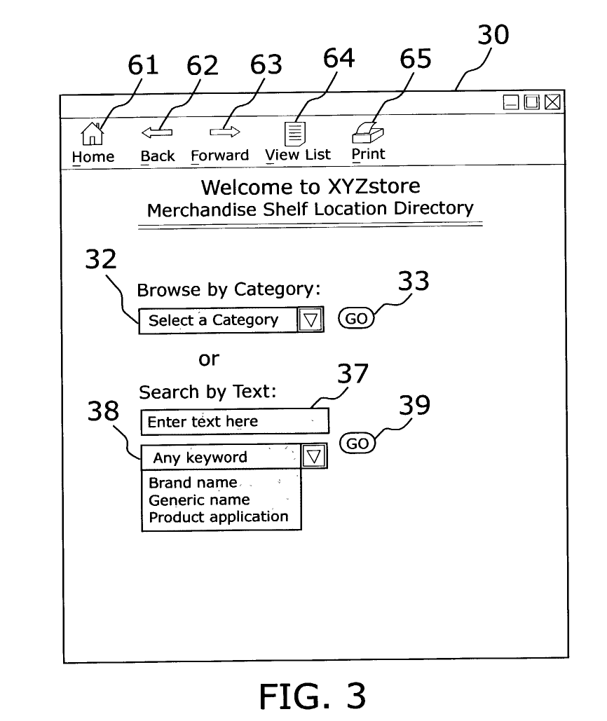

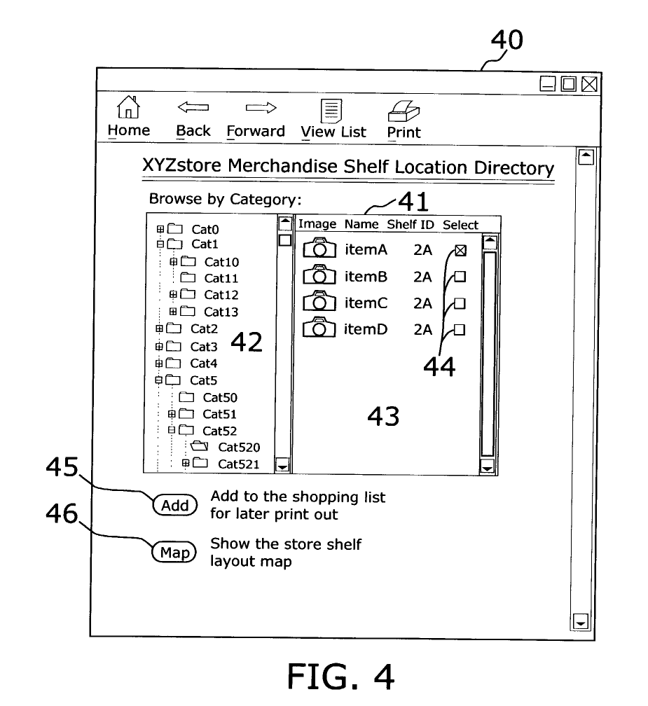

Home page 30 as illustrated in FIG. 3 is the first page to greet a new customer at the terminal 15, and a starting point for browsing or searching the said database. For browsing by category, the customer can select a category in the ‘Browse by Category’ drop-down multiple-choice box 32, and press the button ‘GO’ 33. Then the information processing unit 25 will feed a new ‘Browse by Category’ page 40 onto the terminal screen (refer to FIG. 4). On the ‘Browse by Category’ page 40, the ‘Browse by Category’ window 41 is divided into two panes, the category display pane 42 and item display pane 43. Very much like Microsoft Windows File Explorer, the category display pane 42 lists the entire merchandise category in a hierarchical way. As illustrated in FIG. 4, category ‘Cat1’ contains 4 sub-categories, ‘Cat10’, ‘Cat11’, ‘Cat12’ and ‘Cat13’. A boxed ‘−’ symbol in front of the category folder means it has sub-catagory, and is being extended. A boxed ‘+’ symbol in front of the category folder means it has sub-categories, and is not being extended. Absent of such symbol means this category (‘Cat11’, ‘Cat50’ or ‘Cat520’ in FIG. 4) is already at the lowest level without any sub-catagory. Clicking on a folder symbol will either extend the category to its sub-categories or open it to the list of items contained in it in case that it is already at the lowest level of category (‘Cat520’ in FIG. 4). Then the item display pane 43 will display all the items in an opened category. As shown in FIG. 4, merchandise items, ‘itemA’, ‘itemB’, ‘itemC’ and ‘itemD’ are contained in the opened category ‘Cat520’. Product image (thumb nail image, double clicking on it can open a larger image window), name and shelf ID along with a select box 44 are displayed in the item display pane 43. If any displayed item is what the customer desired, he or she can click the select box 44 next to it, and then click the ‘Add’ button 45, to add the item or items in case of multiple selections, to the shopping list for later review and printing out. After adding the selected items to the shopping list, all the selected boxes 44 will be cleared, and the customer can continue to browse other categories in the same ‘Browse by Category’ page 40. For those customers not familiar with the store floor plan, they can click the ‘Map’ button 46 to pup up a separate window of store shelf layout map.

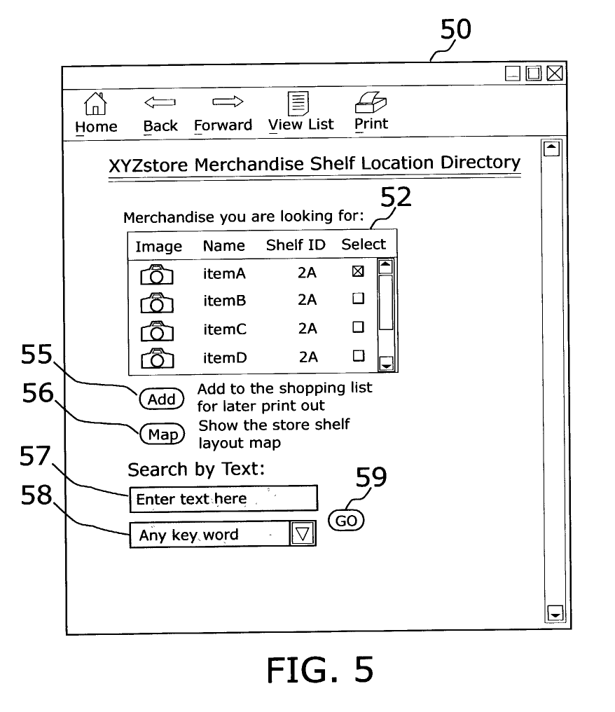

For those customers who choose to search for a merchandise item by keywords, can enter the keyword(s) in the ‘Search by Text’ text box 37 in home page 30 of FIG. 3, and then select a search criteria in the drop down multiple-choice box 38. In the FIG. 3 illustrated embodiment, one can choose ‘Brand name’, ‘Generic name’, ‘product application’ or leave the default ‘Any keyword’ in the multiple-choice box 36. Press the ‘GO’ button 39 to start the search. Then the information processing unit 25 will send a search result page 50 in FIG. 5 to the terminal screen. It may contain a text line, ‘Sorry, no match was found’ and prompt you to search by other keyword(s); or a window 52 showing all the matched items with thumb nail images, names, shelf IDs and select boxes. If any item is indeed the desired item by the customer, he or she can click the select box next to it, and then click the ‘Add’ button 55 to add the selected items to the shopping list for later review and printing out—the same procedure as in page 40 of FIG. 4. Clicking the ‘Map’ button 56 show the store shelf layout map. The ‘Search by Text’ box 57 and search criteria multiple-choice box 58 and ‘GO’ button 59 are also present in the search result page 50 for customers to further search by other keyword(s). Certain buttons, ‘Home’ 61, ‘Back’ 62, ‘Forward’ 63, ‘View List’ 64, ‘Print’ 65, are shared functional buttons among all the screen pages 30, 40 and 50, anyone who are familiar with computer graphical user interface (such as Microsoft Windows) or internet browsers (such as Microsoft Explorer) shall have no difficulty to figure out the use of them. For example, when ‘Home’ 61 is pressed, the screen will go right back to the home page 30; when ‘View List’ 64 is pressed, the screen will go to a page listing all the selected merchandise items with their names and shelf location IDs; and when ‘Print’ 65 is pressed, the terminal 15 attached printer16 will print out the whole list of the selected merchandise items. With the shelf location IDs in hand, the customer can go directly to the store shelves where the desired merchandises are located, instead of roaming the aisles.

What is claimed is

1. A merchandise shelf location directory system for use in a retail facility to allow its customers to conduct self-search for merchandise shelf locations, the merchandise shelf location directory system comprising:
(a) at least one storage device that is operative to store a database of merchandise items the retail facility carries;
(b) a plurality of terminal computers that are operative for the retail facility customers to conduct self-search in the said database, and to selectively retrieve the search results which contain the desired merchandise shelf location information, from the said database;
(c) at least one information processing unit that is operative to manage the data flow between the said database and the said terminal computers;
(d) a plurality of computer networking devices for connecting the said storage device, the said terminal computers and the said information processing unit to form a networked computer system;

2. The directory system of claim 1, wherein the database of merchandise items comprises a plurality of data items which include:
(a) the merchandise shelf location identification;
(b) the merchandise inherent information, such as the category name, brand name, generic name and product applications for querying the said database;

3. The directory system of claim 1, wherein the database of merchandise items is programmed to be searched by using methods selected from a group consisting of browsing by category names and searching by keywords;

4. The directory system of claim 1, wherein the database of merchandise items is programmed to handle simultaneously a plurality of accesses from the said plurality of terminal computers;

5. The directory system of claim 1, wherein the terminal computer comprises input means for the retail facility customers to enter texts, make selections and initiate commands;

6. The directory system of claim 5, wherein the input means comprises devices selected from the group consisting of computer keyboard, mouse and touch-screen;

7. The directory system of claim 1, wherein the networked computer system is programmed to be able to store the selections of merchandise information by the retail facility customers;

8. The directory system of claim 1, wherein the terminal computer comprises output means for the retail facility customers to obtain the selected merchandise information;

9. The directory system of claim 8, wherein the output means comprises devices selected from the group consisting of computer monitor, printer and audio loudspeakers.
